(19) United States
(12) Patent Application Publication
(10) Pub. No.: US 2023/0199078 A1
(43) Pub. Date: Jun. 22, 2023

(54) ACCELERATION OF MICROSERVICE COMMUNICATIONS

(71) Applicant: Intel Corporation, Santa Clara, CA (US)

(72) Inventors: Beeresh GOPAL, Bengaluru (IN); Monika KASHID, Bengaluru (IN); Utkarsha GANGTHADE, Digras (IN); Manan GUPTA, Delhi (IN); Mrittika GANGULI, Chandler, AZ (US)

(21) Appl. No.: 18/110,792

(22) Filed: Feb. 16, 2023

(51) Int. Cl. H04L 67/51; H04L 67/2885

(52) U.S. Cl. CPC H04L 67/51; H04L 67/2885

(57) ABSTRACT

Examples described herein relate to execution of an ingress service to select at least one service to process at least one received packet. In some examples, the ingress service is executed on a frequency tuned processor of one or more processors, accessing a forwarding table from high bandwidth memory (HBM), and utilizing data copy circuitry to copy portions of received packets to memory accessible to the selected services.

### BACKGROUND

A service can be executed using a group of microservices executed on different servers. Microservices can communicate with other microservices using packets transmitted over a network using an interface to a service mesh. A service mesh can include a infrastructure layer for facilitating service-to-service communications between microservices using application programming interfaces (APIs). A service mesh can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth.

### BRIEF DESCRIPTION OF THE DRAWINGS

FIG. 1 depicts an example system.

FIG. 2 depicts an example cluster environment.

FIG. 3 depicts an example of storage of forwarding tables.

FIG. 4 depicts an example of core prioritization using resource allocation.

FIG. 5 depicts an example process.

FIG. 6 depicts an example system.

FIG. 7 depicts an example system.

### DETAILED DESCRIPTION

In a system that executes microservices, latencies can arise from error handling, reporting of distributed states, and other communications via interprocess communications (IPC). During IPC communications, to determine routing of a network packet, a forwarding table (e.g., Internet Protocol (IP) table data structure) can be accessed within an operating system (e.g., Linux Kernel). For example, the forwarding table can be accessed by a Linux Kernel for packet forwarding within a central processing unit (CPU) socket or among various systems via a network or fabric.

At least to attempt to reduce latencies from inter-service communications, such as communications to a cluster of one or more services, one or more of the following technologies can be used: reading and writing of forwarding tables using a memory such as High Bandwidth Memory (HBM) to reduce proximity of storage of forwarding tables (e.g., IP table data structure) to cores; tuning of frequency of operation of one or more cores that execute ingress processes for a cluster to increase a rate of load balancing and distribution of messages among services; and/or use of a data mover circuitry to copy and write messages from incoming packets to memory accessible to one or more target services to process the messages. For example, cloud service providers (CSPs) can tune performance of service mesh communications and interfaces to service meshes using technologies described herein.

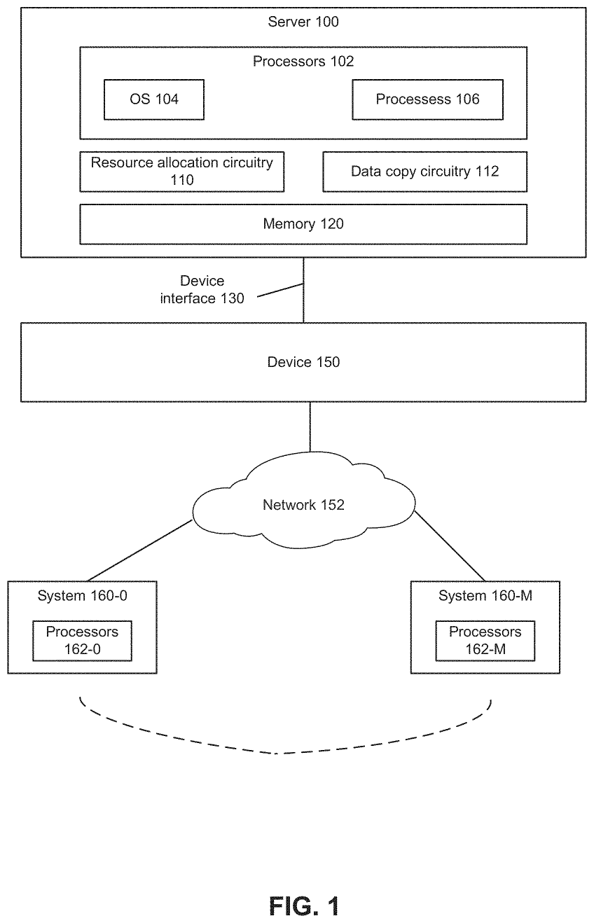

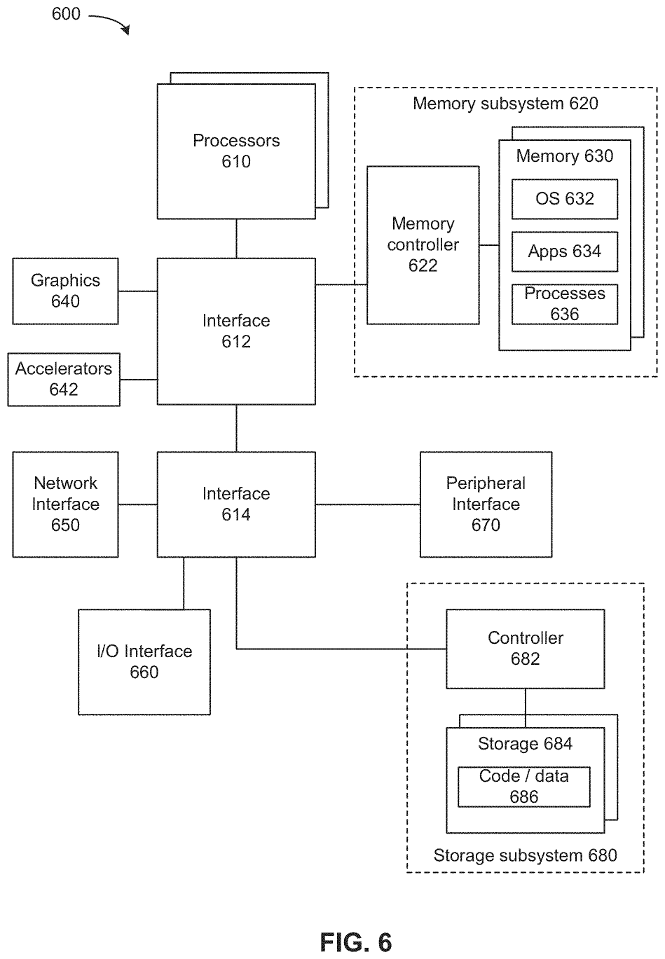

FIG. 1 depicts an example system. Host server system 100 can include at least processors 102 and memory 120. Various examples of hardware and software utilized by host server system 100 as well as one or more of systems 160-0 to 160-M, where M is an integer value of 1 or more, are described at least with respect to FIG. 6. For example, processors 102 can include one or more of: a CPU, graphics processing unit (GPU), accelerator, or other processors described herein. Processors 102 can access instructions or data stored in memory 120.

For example, memory 120 can include one or more of: one or more registers, one or more cache devices (e.g., level 1 cache (L1), level 2 cache (L2), level 3 cache (L3), last level cache (LLC)), one or more volatile memory device, one or more non-volatile memory device, and/or one or more persistent memory device. For example, memory 120 can include static random access memory (SRAM) memory technology or memory technology consistent with high bandwidth memory (HBM) (e.g., JESD325, originally published by JEDEC in October 2013), HBM version 2 (HBM2), double data rate (DDR), or others or combinations of memory technologies, and technologies based on derivatives or extensions of such specifications. For example, memory 120 can include dual in-line memory modules (DIMMs) and/or one or more of memory pools. Memory 120 can be accessed through a device interface (e.g., Peripheral Component Interconnect express (PCIe), Compute Express Link (CXL), or others), switch, and/or network via a network interface device.

Host server system 100 can communicate with device 150 using a device or memory interface 130 that operates in a manner consistent with one or more of: PCIe, CXL, Universal Chiplet Interconnect Express (UCIe), DDR, or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

Various examples of device 150 include one or more of: a network interface device, accelerator, storage device, memory device (e.g., memory pool with dual inline memory modules (DIMMs)), graphics processing unit, audio or sound processing device, and so forth. In some examples, network interface device can refer to one or more of: a network interface controller (NIC), a remote direct memory access (RDMA)-enabled NIC, SmartNlC, router, switch, forwarding element, infrastructure processing unit (IPU), data processing unit (DPU), or network-attached appliance (e.g., storage, memory, accelerator, processors, and/or security).

Device 150 can be accessible by processes 106 or OS 104 as a shared virtual device by system 100 using virtualization technologies including: Single Root Input Output Virtualization (SRIOV) (e.g., Single Root I/O Virtualization (SR-IOV) and Sharing specification, version 1.1, published Jan. 20, 2010 by the Peripheral Component Interconnect (PCI) Special Interest Group (PCI-SIG) and variations thereof), Intel® Scalable I/O Virtualization (SIOV) (e.g., Intel® Scalable I/O Virtualization Technical Specification, revision 1.0, June 2018), virtio, or other specifications, as well as earlier versions, later versions, and variations thereof.

In some examples, one or more of processors 102 and/or device 150 can execute operating system (OS) 104 and one or more processes 106. Processes 106 can include one or more of: application, process, thread, a virtual machine (VM), microVM, container, microservice, or other virtualized execution environment. In some examples, processes 106 can include an ingress service to load balance processing of messages and route messages to particular processes for processing. For example, an ingress service can include an ingress service built with compilers to use data copy circuitry 112, resource allocation circuitry 110, and/or HBM memory in memory 120, as described herein. For example, the ingress service can operate in a manner consistent with a service mesh proxy such as one or more of: Envoy, Istio, NGINX, linkerd, Trailblazer, HAProxy, or others. Envoy is described at least in https://www.envoyproxy.io/ or available from Cloud Native Computing Foundation.

IP tables can include forwarding tables that control network traffic and provide a packet filter and firewall, to route network traffic based on an array of criteria, including, but not limited to, port, protocol, and destination IP address. IP tables can define rules for particular destination IP addresses. In a microservices architecture, services executing on nodes running on a platform can communicate based on configurations of IP tables. IP tables can be frequently accessed by services (e.g., one or more of processes 106) to obtain information and details about packet filtering, address translation, and other rules utilized to process packets. With an increase in number of services, repeated accesses to IP tables can result in more input/output (I/O) traffic and increased latencies of communications between services.

In some examples, OS 104 can allocate IP tables in memory 120 such as HBM or other memory technologies including cache or DDR-based memory. Storing IP tables in HBM can decrease a physical distance between a processor and IP tables or otherwise reduce latency to access IP tables by the processor that executes an ingress service that accesses at least one of the IP tables. In some examples, HBM and other memory can be accessible as separate non-uniform memory access (NUMA) nodes and HBM can provide for faster access of IP tables or forwarding tables by a CPU socket or NUMA node (IPC) by a service (e.g., business logic, pod, or node).

In some examples, a process that performs ingress processing of messages received in a cluster can be allocated by a hypervisor or orchestrator to execute on a processor 102 and processor 102 has a clock frequency of operation that is tunable using resource allocation circuitry 110. For example, operations of resource allocation circuitry 110 can include per core performance tuning based on class of service (CLOS) of a service that executes on the core or priority level of packets processed by the core to adjust frequency of operations of the core. For example, a priority level of the process can be set as high based on the process performing ingress processing of packets received at a cluster. For example, priority of CLOS of packets can be based on priority level of network traffic (e.g., IEEE 802.1p and/or q tags). For example, a priority of CLOS of packets that are inter-microservice traffic can be set to high. Resource allocation circuitry 110 can increase a frequency of operations of a core, processors, or devices that execute ingress service processes that process packets that are designated as high.

In some examples, a process that performs ingress processing of messages received in a cluster can utilize resource allocation circuitry 110 to distribute messages to target processes. For example, operations of resource allocation circuitry 110 can be performed by Intel® Resource Director Technology (RDT), or technologies can be used with other processor designers or manufacturers including ARM®, Qualcomm®, IBM®, Nvidia®, Broadcom®, Texas Instruments®, among others.

In some examples, a process that performs ingress processing of messages received in a cluster can utilize data copy circuitry 112 to copy ingress messages to memories allocated to destination services. Destination or target services can be executed by a CPU socket of processors 102 and/or one or more of systems 160-0 to 160-M, where M≥1, accessible via network 152. Data copy circuitry 112 can perform one or more of: direct memory access (DMA) read or copy operations, read data from a queue, write data to a queue, generate and test cyclic redundancy check (CRC) checksum, or Data Integrity Field (DIF) to support storage and networking applications; memory compare and delta generate/merge, memory deduplication, input-output memory management unit (IOMMU) operations, as well as PCIe Address Translation Services (ATS), Page Request Services (PRS), Message Signaled Interrupts Extended (MSI-X), and/or Advanced Error Reporting (AER). In some examples, data copy circuitry 112 can be implemented as Intel® data streaming accelerator (DSA).

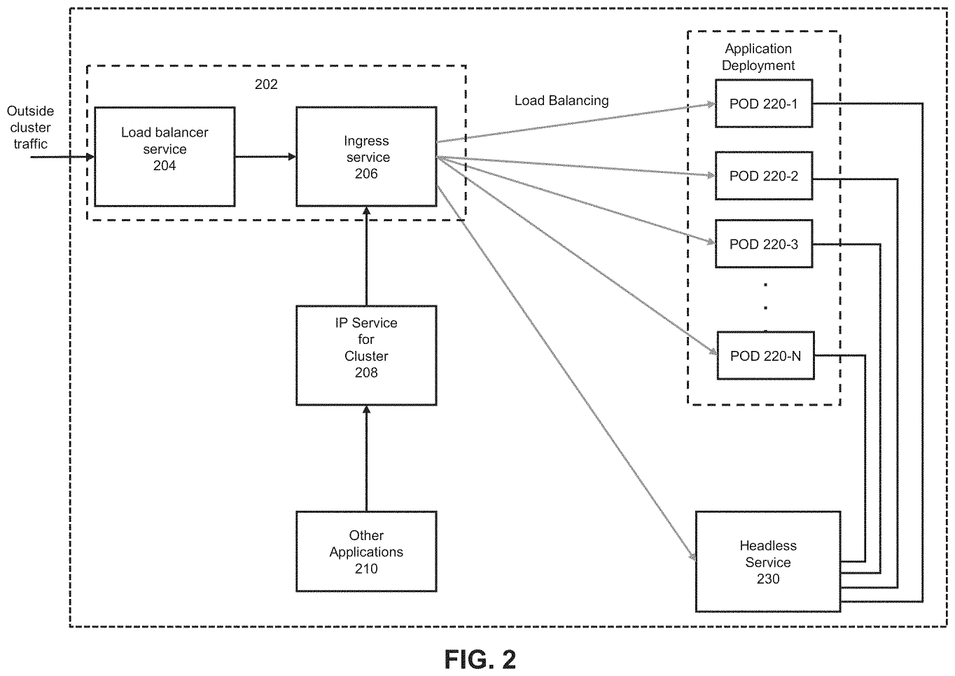

FIG. 2 depicts an example cluster environment. In some examples, the cluster environment can be consistent with Kubernetes, or others such as Azure Container Instances, Docker, Amazon Web Services (AWS) Fargate, or other distributed container or microservice environments. For example, one or more processors in a server or other system (e.g., network interface device) can execute ingress infrastructure service 202, which can perform load balancer 204 and ingress service 206. For example, one or more processors in a same or different server(s) or other system(s) (e.g., network interface device(s)) can execute services or pods 220-1 to N, where N is an integer that is 2 or more.

Layer 7 (L7) load balancer 204 can select a destination or target service to process a message received by ingress infrastructure service 202. L7 routing can be performed using YAML objects configured dynamically by an ingress controller. In some examples, a single instance of load balancer 204 can load balance processing of packet traffic from an outside cluster among N number of services (e.g., pods 220-1 to 220-N), depending upon a load balancing policy. Static or dynamic load balancing policies can include round robin, weighted round robin, priority, weighted least connection, weighted response time, resource based, or others. For received network packets, ingress can be a single point of entry into a cluster and can be a bottleneck of inflow of packets. Where there is high network traffic, when or after a bottleneck of the forwarding operation is detected based on packet inflow rate, a control plane (e.g., orchestrator) can instantiate another instance of ingress service 202 to balance the load.

In some examples, load balancer service 204 can utilize work queues accessible to data copy circuitry to provide messages to one or more pods 220-1 to 220-N, selected by load balancer service 204, to process the packets. For example, data copy circuitry 112 can be enabled for Kubernetes via a plugin to copy and write messages from incoming packets to memory accessible to one or more pods 220-1 to 220-N assigned to process the incoming packets from outside the cluster.

For example, load balancer service 204 and/or ingress service 206 can be executed on one or more processors with frequency of operations increased to reduce latency of processing packets prior to forwarding to a destination pod. For example, ingress service 206 can access an IP table from HBM to determine an IP address of a destination pod, among pods 220-1 to 220-N, selected by load balancer service 204. For example, ingress service 206 can copy received messages to memory accessible to a destination pod using data copy circuitry.

In some examples, ingress infrastructure service 202 can be implemented as a Kubernetes Envoy ingress pod. However, ingress infrastructure service 202 can be implemented in a manner consistent with Istio, NGINX, linkerd, Trailblazer, HAProxy, or others. Envoy ingress service 206 can route ingress packets from outside of the cluster to one or more of services 1 to N in the cluster as selected by load balancer 204.

A pod among pods 220-1 to 220-N can process packets as a service and communicate with another service to provide results of processed data to the another service. An orchestrator can scale a number of pods N to fewer or more instances based on utilization. A headless service 230 can access a Domain Name Service (DNS) configuration of a node in order to record IP addresses of pods 220-1 to 220-N. Application headless service 230 can record DNS record with IP addresses of pods 1 to N to be accessed by services running inside the pods. IP services for cluster 208 and other applications 210 in the cluster can configure ingress service with IP addresses of pods 220-1 to 220-N. IP services 208 in the cluster can keep record of IP address of pods. Other applications 210 can coordinate to share resources such as network, hardware, or operating system.

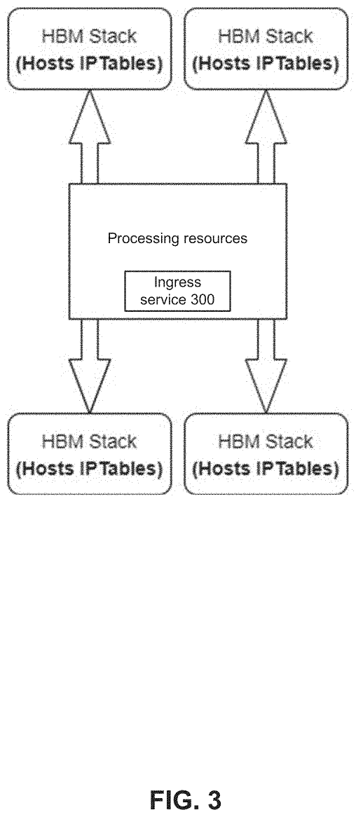

FIG. 3 depicts an example of storage of forwarding tables. For example, processing devices (e.g., cores or accelerators) or network interface devices can execute ingress service 300 that accesses IP Tables from HBM memory (or similar memory) to determine routing and forwarding of packets to IP addresses of pods. Accesses of IP addresses from HBM memory can reduce time to determine forwarding treatments of packets. Other memories can be used such as cache or other volatile or non-volatile memory devices.

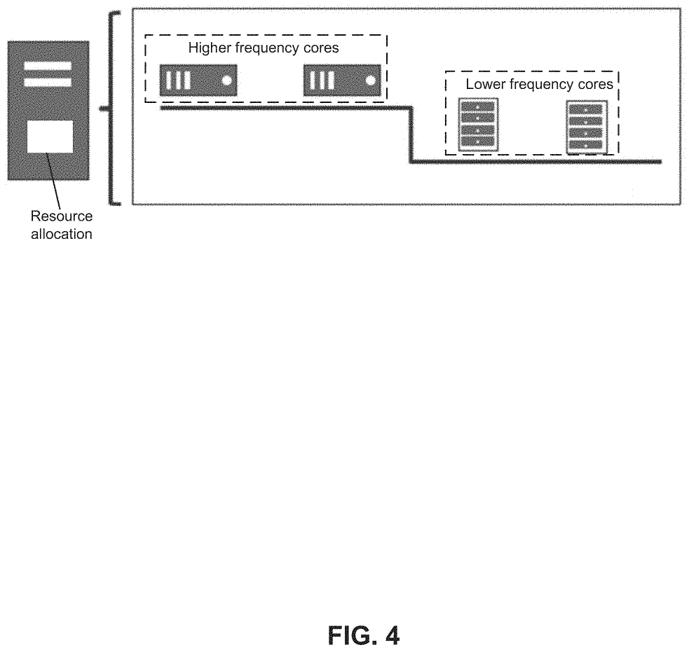

Executing an ingress service on a core operating at a high frequency can accelerate a rate of processing and routing of packets. FIG. 4 depicts an example of core prioritization using resource allocation circuitry. One or more cores in the system can perform operations related to packet processing and adjustment of power and frequency of the one or more cores can be performed using per-core CLOS prioritization. The one or more cores can perform processes that perform packet processing tasks such as load balancing and identification of destination IP addresses of target pods (L7 ingress). The core executing an ingress infrastructure service can be assigned a “high priority” and a greater base frequency can be set for the core. Where a system's maximum power budget is a constant, excess power budget remaining while the other cores are running pods can be allotted to a high-priority core executing an ingress infrastructure service while ensuring the operating frequency of the core can remain at an allocated higher frequency. A base frequency of a core can be increased to a greater level than that defined for the system. Increasing a frequency of a core that executes an ingress infrastructure service can decrease the possibility of facing a bottleneck in operations to be handled by the kernel.

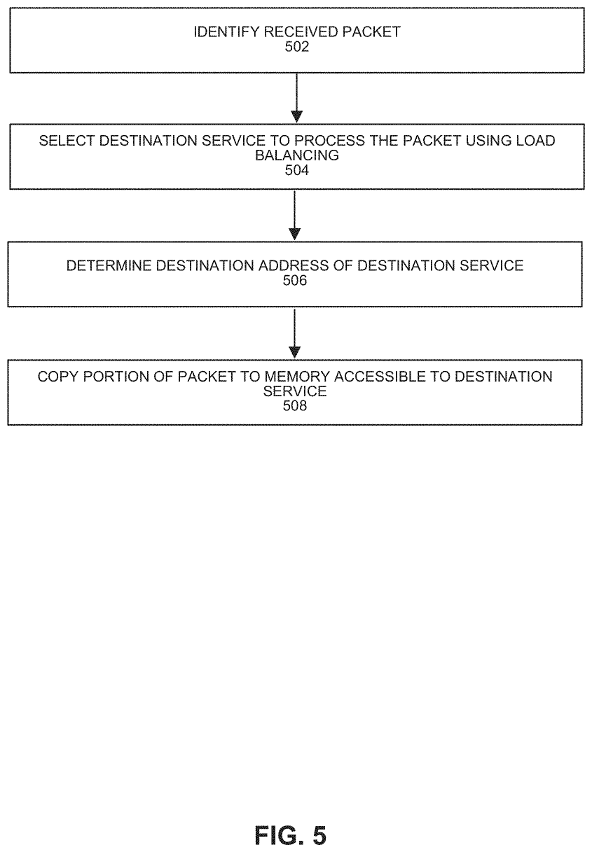

FIG. 5 depicts an example process. The process can be performed to execute an ingress infrastructure service for a cluster of services, in some examples. At 502, the ingress infrastructure service can identify a received packet and determine a service to process the packet. For example, the ingress infrastructure service can execute on a processor that operates at a frequency that is set at a high level for a CPU socket using resource allocation circuitry. At 504, the ingress infrastructure service can load balance among destination services to select a destination service to process the received packet. At 506, the ingress infrastructure service can identify an IP address of a destination service to process the received packet. For example, the ingress infrastructure service can access an IP table stored in HBM or other memory to determine an IP address of a destination service to process the received packet. At 508, the ingress infrastructure service can copy the received packet to a memory accessible to the destination service. In some examples, the ingress service can copy one or more portions of the received packet to the memory accessible to the destination service by use of a data copy circuitry. The destination service can perform processing of the packet content related to one or more of: machine learning training, machine learning inference (e.g., image recognition, fraud detection, or others), a web server, or other business logic. The destination service can communicate with a pod in the same cluster or other cluster.

FIG. 6 depicts a system. The system can use embodiments described herein to execute an ingress service that utilizes accelerators in connection with determination of routing of ingress packets to a cluster and copying of messages to a destination service, as described herein. System 600 includes processors 610, which provides processing, operation management, and execution of instructions for system 600. Processors 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processors 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 610 can include one or more processor sockets.

In some examples, interface 612 and/or interface 614 can include a switch (e.g., CXL switch) that provides device interfaces between processors 610 and other devices (e.g., memory subsystem 620, graphics 640, accelerators 642, network interface 650, and so forth). Connections provide between a processor socket of processors 610 and one or more other devices to execute an ingress service that utilizes accelerators in connection with determination of routing of ingress packets to a cluster and copying of messages to a destination service, as described herein.

In some examples, system 600 includes interface 612 coupled to processors 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die.

Accelerators 642 can be a programmable or fixed function offload engine that can be accessed or used by a processors 610. For example, an accelerator among accelerators 642 can provide compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processors 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Applications 634 and/or processes 636 can refer instead or additionally to a virtual machine (VM), container, microservice, processor, or other software. Processes 636 represent agents or routines that provide auxiliary functions to OS 632 or one or more applications 634 or a combination. In some example, memory subsystem 620 includes memory controller 622, which is a memory controller to generate and issue commands to memory 630. It will be understood that memory controller 622 could be a physical part of processors 610 or a physical part of interface 612. For example, memory controller 622 can be an integrated memory controller, integrated onto a circuit with processors 610.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In some examples, system 600 includes interface 614, which can be coupled to interface 612. In some examples, interface 614 represents an interface circuit, which can include standalone components and integrated circuitry. In some examples, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory.

In some examples, network interface 650 can be implemented as a network interface controller, network interface card, a host fabric interface (HFI), or host bus adapter (HBA), and such examples can be interchangeable. Network interface 650 can be coupled to one or more servers using a bus, PCIe, CXL, or DDR. In some examples, network device 650 can refer to one or more of: a network interface controller (NIC), a remote direct memory access (RDMA)-enabled NIC, SmartNlC, router, switch, forwarding element, infrastructure processing unit (IPU), data processing unit (DPU), or network-attached appliance (e.g., storage, memory, accelerator, processors, and/or security). Some examples of network device 650 are part of an IPU or DPU or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In some examples, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In some examples, system 600 includes storage subsystem 680 to store data in a nonvolatile manner. In some examples, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processors 610. Whereas storage 684 is nonvolatile, memory 630 can include volatile memory (e.g., the value or state of the data is indeterminate if power is interrupted to system 600). In some examples, storage subsystem 680 includes controller 682 to interface with storage 684. In some examples controller 682 is a physical part of interface 614 or processors 610 or can include circuits or logic in processors 610 and interface 614.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 6G, and variations thereof. Data can be copied or stored to virtualized storage nodes or accessed using a protocol such as Non-volatile Memory Express (NVMe) over Fabrics (NVMe-oF) or NVMe.

In some examples, system 600 can be implemented using interconnected compute nodes of processors, memories, storages, network interfaces, and other components. High speed interconnects can be used such as PCIe, Ethernet, or optical interconnects (or a combination thereof). System 600 may be embodied as part of a system-on-a-chip (SoC) that includes one or more processors, or included on a multichip package that also contains one or more processors.

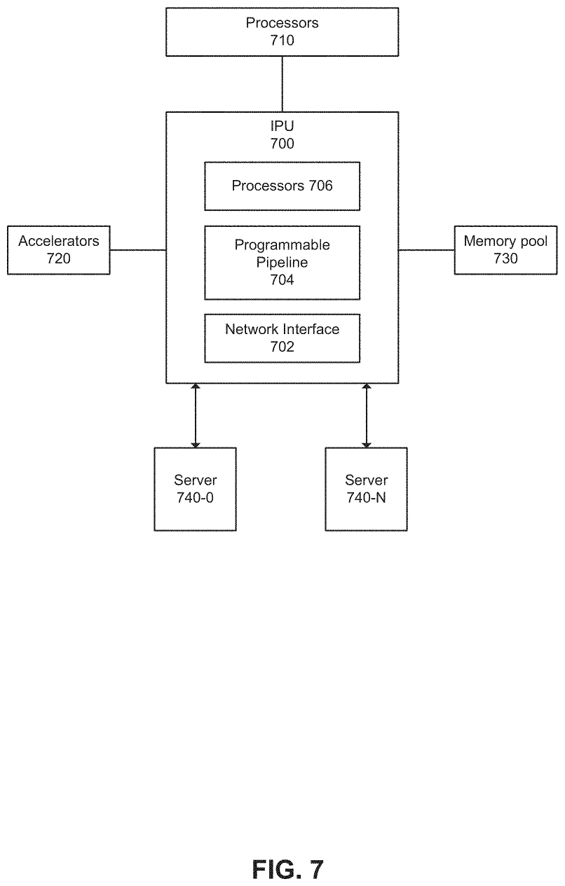

FIG. 7 depicts an example network interface device. Network interface device 700 manages performance of one or more processes using one or more of processors 706, processors 710, accelerators 720, memory pool 730, or servers 740-0 to 740-N, where N is an integer of 1 or more. In some examples, processors 706 of network interface device 700 can execute one or more processes, applications, VMs, containers, microservices, and so forth that request performance of workloads by one or more of: processors 710, accelerators 720, memory pool 730, and/or servers 740-0 to 740-N. Network interface device 700 can utilize network interface 702 or one or more device interfaces to communicate with processors 710, accelerators 720, memory pool 730, and/or servers 740-0 to 740-N. Network interface device 700 can utilize programmable pipeline 704 to process packets that are to be transmitted from network interface 702 or packets received from network interface 702.

Programmable pipeline 704 and/or processors 706 can be configured or programmed using languages based on one or more of: P4, Software for Open Networking in the Cloud (SONiC), C, Python, Broadcom Network Programming Language (NPL), NVIDIA® CUDA®, NVIDIA® DOCATM, Infrastructure Programmer Development Kit (IPDK), or x86 compatible executable binaries or other executable binaries. Programmable pipeline 704 and/or processors 706 can be configured to perform event processing using an accelerator or other circuitry in line with network interface device 700 at least where network interface device is to execute an ingress service that utilizes accelerators in connection with determination of routing of ingress packets to a cluster and copying of messages to a destination service, as described herein.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least some examples may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

What is claimed is:

1. At least one non-transitory computer-readable medium comprising instructions stored thereon, that if executed by one or more processors, cause the one or more processors to:
execute an ingress service to select at least one service to process at least one received packet, wherein the ingress service is executed on a frequency tuned processor of the one or more processors, accessing a forwarding table from high bandwidth memory (HBM), and utilizing data copy circuitry to copy portions of received packets to memory accessible to the selected at least one service.

2. The computer-readable medium of claim 1, wherein the ingress service performs load balancing of received packets among the at least one service.

3. The computer-readable medium of claim 1, wherein the ingress service identifies an Internet Protocol (IP) address of services to process the received packet.

4. The computer-readable medium of claim 1, wherein the ingress service is to access the forwarding table to determine a destination service to process the received packet.

5. The computer-readable medium of claim 1, wherein the frequency tuned processor of the one or more processors comprises a core operating at a higher frequency.

6. The computer-readable medium of claim 1, wherein the ingress service is to utilize the data copy circuitry to copy the received packet to memory accessible to the selected at least one service to process the received packet.

7. The computer-readable medium of claim 1, wherein the forwarding table comprises a Kubernetes IP table and the ingress service is to operate in a manner consistent with Kubernetes.

8. A method comprising:
performing an ingress service to select at least one service for processing at least one received packet, wherein the ingress service is executed on a frequency tuned processor of one or more processors, accessing a forwarding table from high bandwidth memory (HBM) memory, and utilizing data copy circuitry to copy portions of the at least one received packet to memory accessible to the selected at least one service.

9. The method of claim 8, wherein the ingress service performs load balancing of the at least one received packet among the at least one service.

10. The method of claim 8, wherein the ingress service identifies an Internet Protocol (IP) address of services to process the at least one received packet.

11. The method of claim 8, wherein the ingress service accesses the forwarding table to determine a destination service to process the at least one received packet.

12. The method of claim 8, wherein the frequency tuned processor of the one or more processors comprises a frequency boosted processor.

13. The method of claim 8, wherein the ingress service utilizes the data copy circuitry to copy the at least one received packet to memory accessible to the selected at least one service to process the at least one received packet.

14. A system comprising:
at least one memory, wherein the at least one memory comprises high bandwidth memory (HBM) and
at least one processor, wherein the at least one processor is to access instructions from the at least one memory that cause the at least one processor to:
execute an ingress service to select services for processing received packets, wherein the ingress service is executed on a frequency tuned processor of the at least one processor, accessing a forwarding table from the HBM, and utilizing data copy circuitry to copy portions of received packets to memory accessible to the selected services.

15. The system of claim 14, wherein the ingress service is to perform load balancing of received packets among the services.

16. The system of claim 14, wherein the ingress service is to identify an Internet Protocol (IP) address of services to process the received packets.

17. The system of claim 14, wherein the ingress service is to access the forwarding table to determine a destination service to process the received packets.

18. The system of claim 14, wherein the frequency tuned processor of the at least one processor comprises a processor having a frequency of operation increased during execution of the ingress service.

19. The system of claim 14, wherein the ingress service is to utilize the data copy circuitry to copy the received packets to memory accessible to the selected services to process the received packets.

20. The system of claim 14, wherein the high bandwidth memory (HBM) comprises a cache device.
